(19) United States
(12) Patent Application Publication
(10) Pub. No.: US 2009/0068908 A1
(43) Pub. Date: Mar. 12, 2009

(54) FABRIC HAVING A THERMOPLASTIC FUSIBLE YARN, PROCESS OF MAKING A FABRIC CONTAINING A THERMOPLASTIC FUSIBLE YARN, AND FABRIC ARTICLE FORMED WITH A FABRIC CONTAINING A THERMOPLASTIC FUSIBLE YARN

(75) Inventor: MARIA HINCHCLIFF, Freehold, NJ (US)

Correspondence Address: DICKSTEIN SHAPIRO LLP, 1177 AVENUE OF THE AMERICAS (6TH AVENUE), NEW YORK, NY, 10036-2714, US

(73) Assignee: Maidenform, Inc., Iselin, NJ (US)

(21) Appl. No.: 12/208,481

(22) Filed: Sep. 11, 2008

Related U.S. Application Data
(60) Provisional application No. 60/971,785, filed on Sep. 12, 2007.

(51) Int. Cl. B32B 37/04; D03D 15/00

(52) U.S. Cl. 442/181; 156/148; 442/304

(57) ABSTRACT

A fabric that contains a thermoplastic fusible yarn and a process of making a fabric containing a thermoplastic fusible yarn are provided. A fabric article is formed with the fabric containing a thermoplastic fusible yarn.

### CROSS-REFERENCE TO RELATED APPLICATION

This application claims benefit of U.S. Provisional Application No. 60/971,785, filed Sep. 12, 2007, which is hereby incorporated by reference in its entirety.

### FIELD OF THE INVENTION

Various embodiments of the invention relate generally to a fabric containing a thermoplastic fusible yarn, a process of making a fabric containing a thermoplastic fusible yarn, and a fabric article formed with a fabric containing a thermoplastic fusible yarn.

### SUMMARY OF THE INVENTION

A fabric is provided containing a thermoplastic fusible yarn, which, in a preferable embodiment, is not bonded to adjacent yarns in the finished fabric. The fabric can be a woven, knitted or lace fabric that contains a thermoplastic fusible yarn, such as, but not limited to an Elastane yarn, or a Grilon® yarn. The thermoplastic fusible yarn is preferably knitted or woven with other yarns during manufacture of the fabric. For example, the thermoplastic fusible yarn can replace one of the warp and/or weft yarns in the fabric. Additionally or alternatively, the thermoplastic fusible yarn can be knitted or woven throughout the fabric or in one or more localized patterns in the fabric. The thermoplastic fusible yarns allow for attaching one fabric to another fabric with the application of heat to melt and/or fuse the thermoplastic fusible yarn, which eliminates the need for a stitched seam.

A process is provided for making a fabric containing a thermoplastic fusible yarn. It is preferred that during manufacture of the fabric containing the thermoplastic fusible yarn, the thermoplastic fusible yarn is not exposed to a temperature sufficient to soften or melt the thermoplastic fusible yarn. So, for example, manufacturing of the fabric is preferably carried out at temperatures below the softening/melting point of the thermoplastic fusible yarn. In the finished fabric, the thermoplastic fusible yarn is preferably not bonded to adjacent yarns of the fabric.

After the fabric containing the thermoplastic fusible yarn has been made, the fabric and/or the thermoplastic fusible yarn contained therein is then exposed to a temperature sufficient to soften/melt the thermoplastic fusible yarn to allow the fabric to be bonded to another fabric, or to another portion of the same fabric. That is, when the thermoplastic fusible yarn is melted or fused, the fabric can be bonded to another separate fabric or another portion of the same fabric without the need for separate stitching.

A fabric article is also provided which contains one or more fabrics, wherein at least one of the fabrics is woven or knitted with a thermoplastic fusible yarn and the thermoplastic fusible yarn is fused and bonded to another portion of the woven or knitted fabric or another fabric forming a stitchless joint.

### BRIEF DESCRIPTION OF THE DRAWINGS

For the purposes of illustrating the invention, there is shown in the drawings an illustrative form, it being understood however, that the invention is not limited to the precise form shown by the drawings in which:

FIG. 1 shows a fabric material manufactured according to the first embodiment.

FIG. 2 shows a fabric material manufactured according to the second embodiment.

FIG. 3 shows a fabric material manufactured according to the third embodiment.

FIG. 4 shows a fabric material manufactured according to the fourth embodiment.

FIGS. 5 to 7 each show a fabric article formed with a fabric material according to an embodiment of the invention.

### DETAILED DESCRIPTION OF THE EMBODIMENTS

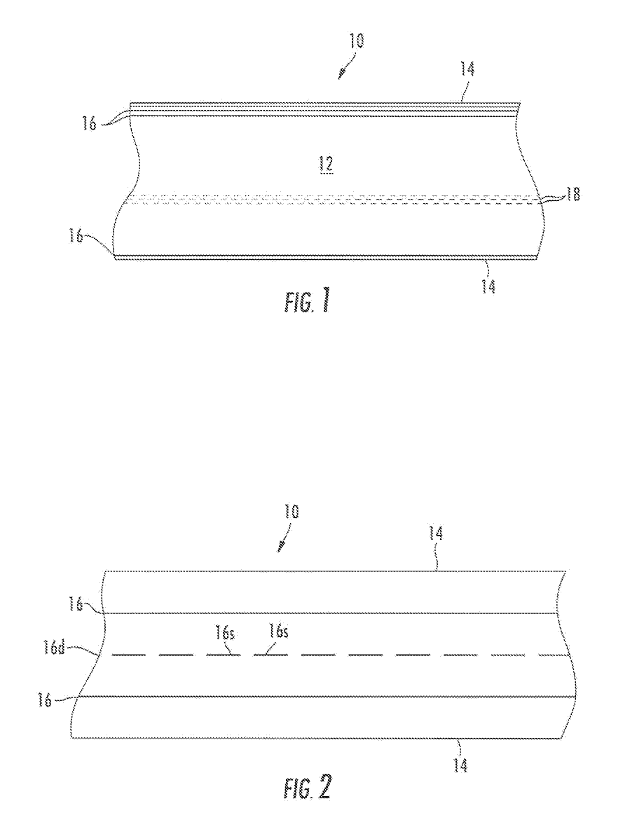

FIG. 1 shows a first embodiment of a fabric material 10 formed for use in making various fabric articles, such as clothing and bedding articles. For example, the fabric material 10 can have an elongated rectangular body portion 12 defined by a pair of longitudinal edges 14. One skilled in the art will appreciate that the fabric material 10 can be formed in various other shapes. The fabric material 10 can be in any of various forms, such as a woven or knitted fabric or a lace fabric. For example, the fabric material 10 can be formed by interwoven warp and weft yarns. One skilled in the art will appreciate that the fabric material 10 can be formed by various other methods, such as by knitting.

The fabric material 10 preferably comprises one or more thermoplastic fusible yarns 16 integrated in the fabric material 10. In the example shown in FIG. 1, the fabric material 10 comprises a plurality of thermoplastic fusible yarns 16 formed along at least one of the longitudinal edges 14. The remaining portion of the fabric material 10 preferably comprises other yarns 18, such as non-thermoplastic fusible yarns.

In a preferred embodiment, the thermoplastic fusible yarns 16 in the fabric material 10 are not thermoplastically bonded to any other yarns (e.g., adjacent non-thermoplastic fusible yarns 18) in the fabric material 10. For example, the manufacture processes of the fabric material 10 is preferably performed at a temperature below the melting temperature of the thermoplastic fusible yarns 16 to avoid the thermoplastic fusible yarns 16 being melted and bonded to their adjacent yarns in the fabric material 10.

In the post manufacturing process, for example when forming a fabric article using the fabric material 10, the thermoplastic fusible yarns 16 can be bonded to another fabric with the application of heat to melt the thermoplastic fusible yarn 16, thereby eliminating the need for a stitched seam between the two pieces of fabric. It should be noted that a fabric article may, after the manufacturing process of the fabric material 10 is complete, be formed by bonding one portion of the fabric material 10 to another portion of the fabric material 10, in which case bonding would take place between thermoplastic fusible yarns of the material and non-thermoplastic fusible yarns of the same material.

Various thermoplastic materials can be used to form the thermoplastic fusible yarns 16. Exemplary thermoplastic materials can include, but not limited to, polyethylene, polypropylene, polyamide, polyester, polyhydrocarbon (e,g., polyolefin), polyurethane or a copolymer of one or more thereof, such as Elastane. For example, the thermoplastic fusible yarn may be a Grilon® yarn, or an Elastane yarn.

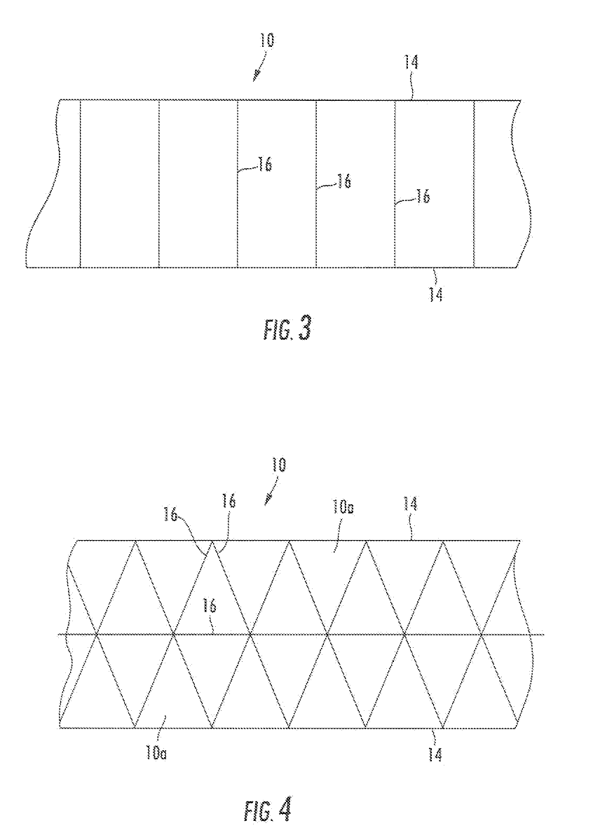

The thermoplastic fusible yarns 16 can be in various forms. For example, the thermoplastic fusible yarns 16 can be formed to have different length or thickness. In one example, the thermoplastic fusible yarn 16 is continuous throughout the entire length or width of the fabric material 10. In another example, the thermoplastic fusible yarn 16 can have a shortened length and formed in a localized area of the fabric material 10 in a discontinuous manner (see FIG. 2). Additionally or alternatively, each thermoplastic fusible yarn 16 can be either single or multiple stranded. One skilled in the art will appreciate that the thermoplastic fusible yarns 16 can be configured in various other forms.

The thermoplastic fusible yarn 16 can be formed in the fabric material 10 in various ways during the manufacture of the fabric material 10. For example, the thermoplastic fusible yarn 16 can be knitted or woven with other yarns during manufacture of the fabric material 10. In one example, each thermoplastic fusible yarn 16 can replace one of the warp and/or weft yarns used to weave the fabric material 10. In another example, the thermoplastic fusible yarns 16 can be woven together with one or more of the warp and/or weft yarns to form an integral fabric material 10. For example, the thermoplastic fusible yarns 16 can be woven with all the warp and/or the weft yarns and formed throughout the fabric material 10. Alternatively, the thermoplastic fusible yarn 16 can be formed in one or more isolated locations in the fabric material 10, such as along the edges 14 of the fabric material 10 shown in FIG. 1.

The thermoplastic fusible yarns 16 can be formed in various patterns. In the example shown in FIG. 1, the thermoplastic fusible yarns 16 can be formed along the longitudinal edges 14 of the elongated fabric material 10. As FIG. 1 shows, one thermoplastic fusible yarn 16 can be formed along one of the longitudinal edges 14 while a plurality of thermoplastic fusible yarns 16 can be formed along the other edge 14. Non-thermoplastic fusible yarns 18 can be present between the edges 14 and form the remaining of the fabric material 10. As will be further described below, such a fabric material 10 can join to another fabric, e.g., along one or both of the longitudinal edges 14 without the need of a stitched seam.

Additionally or alternatively, the thermoplastic fusible yarns 16 can be formed in other locations on the fabric material 10. In the example shown in FIG. 2, a plurality of thermoplastic fusible yarns 16 can he formed in the body portion 12 along the length of the fabric material 10. Among the thermoplastic fusible yarns 16, thermoplastic fusible yarn 16d is formed in a discontinuous manner and contains a plurality of thermoplastic segments 16s. As one skilled in the art will appreciate, the FIG. 2 fabric material 10 can also include thermoplastic fusible yarns 16 along one or both of the edges 14, as is shown in FIG. 1. In the example shown in FIG. 3, the thermoplastic fusible yarns 16 are arranged in the transverse direction of the fabric material 10.

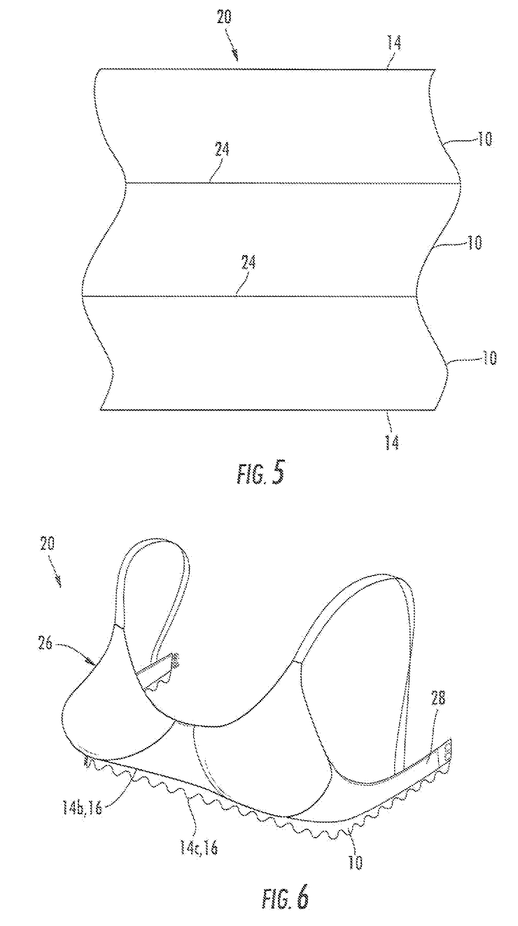

Although FIGS. 2 and 3 each show that the thermoplastic fusible yarns 16 are formed to be parallel to one another, the thermoplastic fusible yarns 16 can be formed to cross one another. For example, as is shown in FIG. 4, the thermoplastic fusible yarns 16 are patterned to form a plurality of fabric units 10a of triangle shapes. In another example shown in FIG. 7, the thermoplastic fusible yarns 16 can be formed to have a curved contour, such as to conform to a body portion the fabric article 20 supports. One skilled in the art will appreciate that the thermoplastic fusible yarns 16 can be formed in various other design patterns (e.g., cartoon characters, flowers, animal shapes), shapes (e.g., circular), and/of forms.

The fabric material 10 can be formed to facilitate the formation of a finished fabric article 20. In one example, the fabric material 10, or its fabric units 10a, can be configured into various shapes to accommodate a particular portion that the finished fabric article 20 is intended to fit. For example, the fabric units 10a are shaped to be used in a garment and will support the user's abdomen. In another example, the non-thermoplastic fusible yarns 18 in the fabric material 10 can be formed of an elastic material so that the finished fabric material 10 can be at least partially stretchable. One skilled in the art will appreciate that the fabric material 10 can be formed in various other shapes and forms for use in various fabric articles 20.

FIGS. 5 to 7 each show a fabric article 20 formed to include at least one fabric material 10. In each fabric article 20, the fabric material 10 can be joined to another portion of the same fabric material 10 or to another fabric 22 including a fabric material 10 without a stitched seam. For example, the thermoplastic fusible yarns 16 in the fabric material 10 can be subjected to heat treatment to a temperature above the melting point of the thermoplastic material causing the thermoplastic fusible yarns 16 to melt. The melted and fused thermoplastic fusible yarns 16 in the fabric material 10 can be pressed against another fabric 22. When the melted thermoplastic fusible yarns 16 are cooled, they are bonded to the other fabric 22, resulting in a stitchless joint 24 attaching the fabric material 10 to the other fabric 22. The fabric article 20 can thereby be formed to have one or more stitchless joints 24 using the thermoplastic fusible yarns 16 contained in the fabric material 10. Neither stitching nor additional adhesive materials are needed in forming such stitchless joint 24. The stitchless joints 24 in the resulting fabric article 20 can provide a smoother appearance and enhanced aesthetic appeal to the fabric article 20.

In one example, the fabric material 10 can be attached to another similarly formed fabric material 10. The thermoplastic fusible yarns 16 in both fabric materials 10 can be used to join the two fabric materials 10 when forming a fabric article 20, resulting in a stronger stitchless joint 24 to enhance the bonding between the two fabric materials 10.

The fabric article 20 can also be formed with both stitchless joints 24 and stitched seams. In such a case, the stitchless joints 24 and the stitched seams can afford different aesthetic appeals to the finished fabric article 20.

FIG. 5 shows a fabric article 20 in the form of a web material. The web material 20 can comprise a plurality of the FIG. 1 fabric materials 10 joined to one another along the longitudinal edges 14. For example, the thermoplastic fusible yarns 16 in a first fabric material 10 are fused and bonded to a second adjacent fabric material 10, which is in turn bonded to a third adjacent fabric material 10. When the thermoplastic fusible yarns 16 in the two adjacent fabric materials 10 are bonded to each other, a stronger joint 24 can be obtained. In addition, each joint 24 is stitchless thereby providing a smoother and more appealing finishing.

The web material 24 can be formed to have either single layer structure or a multi-layer structure with a plurality of fabric materials 10 overlapping one another. Although the web material 20 in FIG. 5 is generally rectangular, it can be formed in various other shapes for use in various occasions. For example, the web material 20 can have a circular shape.

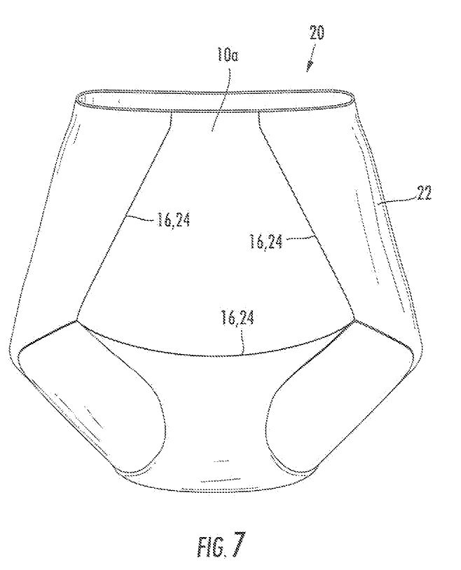

In the example shown in FIG. 6, the fabric material 10 is in the form of a lace trim containing one or more thermoplastic fusible yarns 16 formed along one or both of edges 14b, 14c. The lace trim 10 can be attached to any undergarment 26 (e.g., a brassiere), such as to enhance its appearance. In the example, one of the longitudinal edges 14b on the lace trim 10 can be attached to the bottom rim 28 of the brassiere 26 by heating the thermoplastic fusible yarn 16 formed along that longitudinal edge 14b. The melted thermoplastic fusible yarn 16 can be bonded to the bottom rim 28 without the need of stitching the two. The finished brassiere 26 can thus include a lace trim 10 without employing a stitching seam along the bottom rim 28 of the brassiere 26.

Additionally or alternatively, the lace trim 10 can have its other longitudinal edge 14c formed in a curvy configuration to enhance the aesthetic appeal of the brassiere 26. After the curvy edge 14c is formed on the lace trim 10, heat can be applied to the curvy edge 14c to melt and fuse the thermoplastic fusible yarns 16 formed along the edge 14c to seal the same.

FIG. 7 shows another fabric article 20, such as a shaping garment, in which a fabric unit 10a is joined to one or more shaped fabrics 22. For example, the fabric unit 10a can be a portion of a fabric material 10 formed to provide additional support to a body portion (i.e., the user's abdomen). As FIG. 7 shows, the fabric unit 10a can be formed to have curved contours. One skilled in the art will appreciate that the fabric material 10 and/or the fabric unit 10a can be formed in various other configurations for use in various other fabric articles 20.

The method of making the fabric material 10 will next be described in more details.

The fabric material 10 is preferably formed by weaving or knitting one or more thermoplastic fusible yarns 16 together with other yarns 18, such as non-thermoplastic fusible yarns. For example, the thermoplastic fusible yarns 16 can be combined with or used as the warp and/or weft threads during the weaving process for making the fabric material 10. In the fabric material 10 so formed, the thermoplastic fusible yarns 16 are present throughout the fabric material 10. Alternatively, the thermoplastic fusible yarns 16 can be selectively combined with the warp and/or weft threads during the weaving process. The fabric material 10 so formed can have thermoplastic fusible yarns 16 isolated in one or more localized areas in the fabric material 10. In one example, the thermoplastic fusible yarns 16 can be in any of various patterns, including those shown in FIGS. 1 to 4. One skilled in the art will appreciate the various methods through which various desired patterns of the thermoplastic fusible yarns 16 can be obtained.

The woven or knitted fabric material 10 is preferably subjected to additional fabric processing, including bleaching, dyeing, drying, etc. The various processing steps are preferably carried out at a temperature below the softening/melting point of the thermoplastic fusible yarns 16 so that the thermoplastic fusible yarns 16 are not melted or bonded to adjacent yarns in the finished fabric material 10. The finished fabric material 10 can thus afford a soft feel, as is provided by individual yarns including thermoplastic fusible yarns 16. Additionally or alternatively, as the thermoplastic fusible yarns 16 are not melted during the fabric manufacture, they can be more readily melted and fused for attaching to another fabric 22 to form various fabric articles 20.

While the foregoing description and drawings represent examples of embodiments, it will be understood that various additions, modifications, and substitutions may be made therein as defined in the accompanying claims. In particular, it will be clear to those skilled in the art that other specific forms, structures, arrangements, proportions, materials can be used without departing from the essential characteristics thereof. The presently disclosed embodiments are therefore to be considered in all respects as illustrative and not restrictive.

What is claimed is:

1. A method of making a fabric article having a first fabric containing thermoplastic fusible yarn and a second fabric, the method comprising:
(a) knitting, weaving or otherwise inserting one or more thermoplastic fusible yarns with one or more non-thermoplastic yarns to form the first fabric; and
(b) affixing the first fabric to the second fabric by:
(1) contacting a portion of the first fabric having thermoplastic fusible yarns with a region of the second fabric to which the first fabric is to he affixed;
(2) applying, to at least the contacting portion, heat sufficient to melt and/or fuse the thermoplastic fusible yarns in the first fabric, so as to affix the first fabric with the second fabric to form the fabric article.

2. The method of claim 1, wherein in step (a), the thermoplastic fusible yarns are distributed substantially uniformly throughout the first fabric.

3. The method of claim 1, wherein in step (a), the thermoplastic fusible yarns are isolated to one or more particular regions of the first fabric.

4. The method of claim 3, wherein the one or more particular regions include at least one edge region of the first fabric.

5. The method of claim 4, wherein step (b)(1) comprises contacting the at least one edge region of the first fabric with the region of the second fabric to which the first fabric is to be affixed.

6. The method of claim 1, further comprising, before step (b), processing the first fabric at a temperature below the melting temperature of the thermoplastic fusible yarns.

7. The method of claim 6, wherein the processing comprises at least one of bleaching, dyeing, and drying the first fabric.

8. The method of claim 1, wherein the second fabric also contains thermoplastic fusible yarns.

9. The method of claim 1, wherein the thermoplastic fusible yarns are oriented transverse to the direction of the non-thermoplastic yarns of the first fabric.

10. The method of claim 1, wherein the thermoplastic fusible yarns comprise Elastane yarn.

11. A fabric article formed with a first fabric containing thermoplastic fusible yarn and a second fabric, comprising:
a first fabric inter-knit or interwoven with one or more thermoplastic fusible yarns together with one or more non-thermoplastic yarns;
a second fabric,
the first fabric and the second fabric being affixed to one another without a stitched seam, by a contact between a melted portion of the first fabric having thermoplastic fusible yarns and the second fabric to form the fabric article.

12. The fabric article of claim 11, wherein the thermoplastic fusible yarns are distributed substantially uniformly throughout the first fabric.

13. The fabric article of claim 11, wherein the thermoplastic fusible yarns are isolated to one or more particular regions of the first fabric.

14. The fabric article of claim 13, wherein the one or more particular regions include at least one edge region of the first fabric, wherein the first fabric is affixed to the second fabric at the at least one edge region.

15. The fabric article of claim 11, wherein the second fabric also contains thermoplastic fusible yarns.

16. The fabric article of claim 11, wherein the thermoplastic fusible yarns are oriented transverse to the direction of the non-thermoplastic yarns of the first fabric.

17. The fabric article of claim 11, wherein the thermoplastic fusible yarns comprise Elastane yarn.

18. A fabric containing a thermoplastic fusible yarn, comprising:
one or more thermoplastic fusible yarns interknit, interwoven or otherwise inserted with one or more non-thermoplastic yarns to form the fabric.

19. The fabric according to claim 18, wherein the thermoplastic fusible yarns are distributed substantially uniformly throughout the fabric.

20. The fabric according to claim 18, wherein the thermoplastic fusible yarns are isolated to one or more particular regions of the fabric.

21. The fabric according to claim 20, wherein the one or more particular regions include at least one edge region of the first fabric.

22. The fabric according to claim 20, wherein the one or more particular regions are affixable to a second fabric, or a portion of said fabric other than said one or more particular regions, by application of heat sufficient to melt and/or fuse the thermoplastic fusible yarns.

23. The fabric according to claim 22, wherein the second fabric also contains thermoplastic fusible yarns.

24. The fabric according to claim 18, wherein the thermoplastic fusible yarns are oriented transverse to the direction of the non-thermoplastic yarns of the fabric.

25. The fabric according to claim 18, wherein the thermoplastic fusible yarns comprise Elastane yarn.
